(19) United States
(12) Patent Application Publication
(10) Pub. No.: US 2008/0105447 A1
(43) Pub. Date: May 8, 2008

(54) Remote forcible entry tool

(76) Inventor: Martin Daniel Holmes, Arroyo Grande, CA (US)

Correspondence Address: Mr. Martin Holmes, 1166 E Grande Ave, Arroyo Grande, CA, 93420, US

(21) Appl. No.: 11/593,201

(22) Filed: Nov. 3, 2006

(51) Int. Cl. B25D 17/28

(52) U.S. Cl. 173/90

(57) ABSTRACT

The present invention provides a device which will provide a remotely activated forcible entry device. The device has retractable parts to reduce bulk of the device when in transit. The Device is lighter than traditional battering rams and is used to breach a conventional door without putting emergency personnel in the line of fire. The device uses traditional cartridges to apply force to the doorway without any specialist training.

### CROSS REFERENCE TO RELATED APPLICATIONS

This application claims the priority benefit of U.S. Provisional patent application Ser. No. 60/695,813, filed Jul. 1, 2005.

CROSS-REFERENCE TO RELATED APPLICATIONS:

| | | | |
|---|---|---|---|
| 2490684 | April, 1946 | Gosselin. | |
| 3219316 | May, 1964 | Fried. | |
| 4657225 | April 1987 | Hoehn et al. | |
| 4681171 | July 1987 | Kee et al. | 173/90 |
| 4783053 | November 1988 | Yirmiyahu | |
| | | et al. | |
| 4960265 | October 1990 | Nichols | |
| 5088174 | February, 1992 | Hull | 29/275. |
| 5167043 | December 1992 | Lopez et al. | 29/254 |
| 5177850 | January, 1993 | Hull et al. | 29/254 |
| 5415241 | May, 1995 | Ruffu et al. | 173/212 |
| 6035946 | March 2000 | Studley, et al. | 173/90, 173/91, 173/128 |

### STATEMENT REGARDING FEDERALLY SPONSORED RESEARCH OR DEVELOPMENT

Not Applicable

### BACKGROUND OF THE INVENTION

In emergency situations where access into a building or room is critical, such as to save lives or property, for example, gaining access through locked, jammed, or otherwise secured doors must be accomplished as rapidly as possible in order to protect human life and to preserve evidence for use in prosecuting unlawful acts. Currently, the procedures in use to gain entry through locked or jammed doors that open inward is to use a battering ram or heavy hammer to destroy the door. In certain circumstances the use of explosives are sanctioned. Current procedures in use today take too much time and place personnel in the direct line of fire when the door is breached or require specialists trained in explosives. Thus, it is desirable to have a tool that can be remotely operated and will enable emergency personnel faster entry and egress through such doors without the use of explosive specialists.

Current devices fail in 6 major areas:
1) Place personnel in the line of fire.
2) Unacceptable weight and complexity.
3) Unacceptable size.
4) Time consuming setup/installation.
5) Too expensive.
6) Require specialists training for use.

### BRIEF SUMMARY OF THE INVENTION

The Remote forcible entry tool is a remote activated device to assist in the forced entry of commercial and residential doors for the emergency services. An explosive cartridge with a primer is used to power a hammer to strike key points on a conventional door. The device is place with its foot under the door and the hammerhead placed perpendicular to the door and aligned to strike the lock or hinges. The device is actuated by the mechanical striking of the cartridge primer via a pull cord from a remote location.

### BRIEF DESCRIPTION OF THE SEVERAL VIEWS OF THE DRAWING

FIG. 1. front isometric view of door with battering ram in passive mode

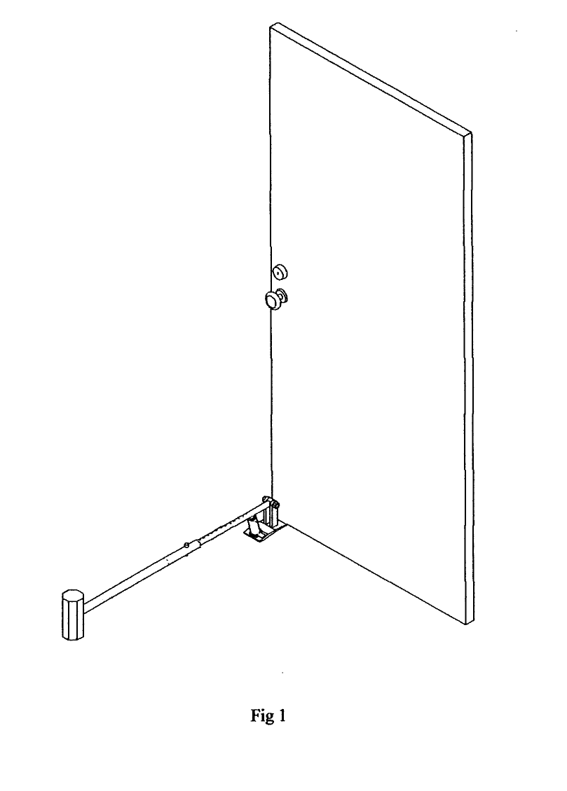

FIG. 2. front isometric view of battering ram in active mode showing hammer striking a door.

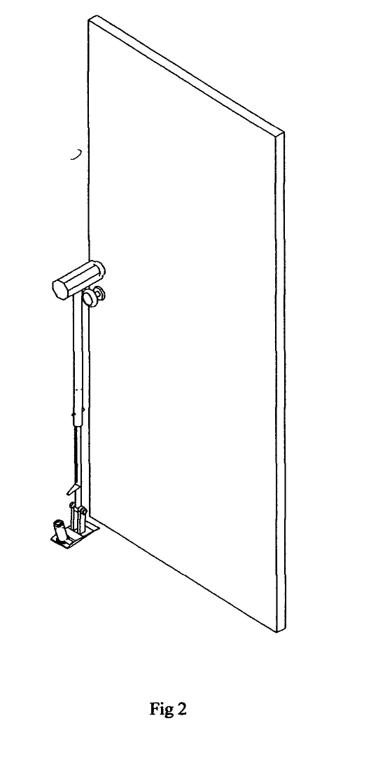

FIG. 3. close up plan view of battering ram footplate.

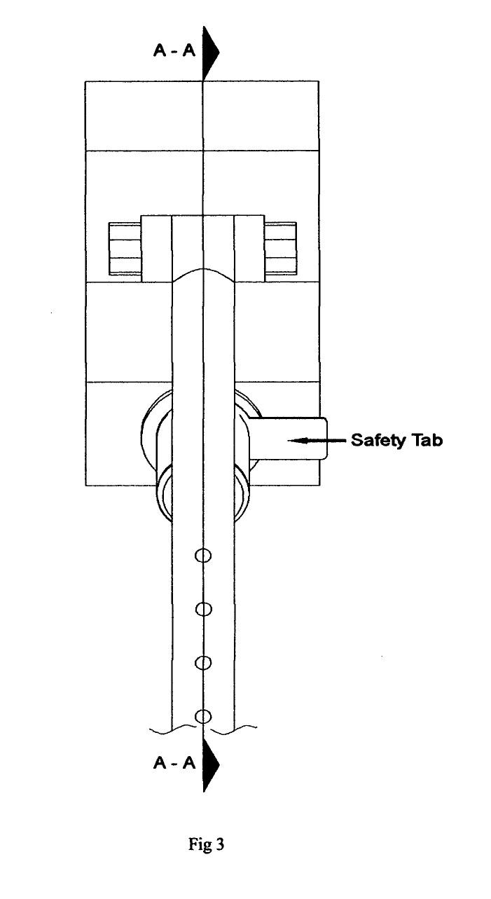

FIG. 4 Section A-A.

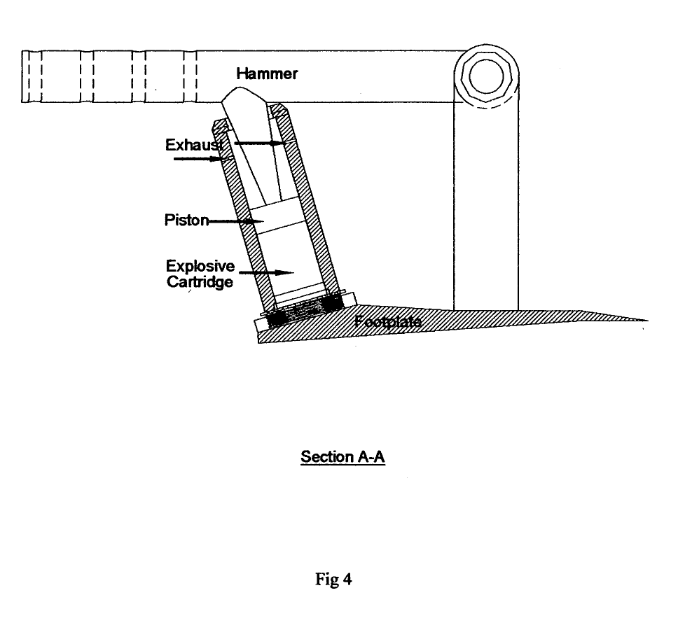

FIG. 5. Isometric view of battering ram in the striking position showing the barrel assembly removed for insertion of explosive charge

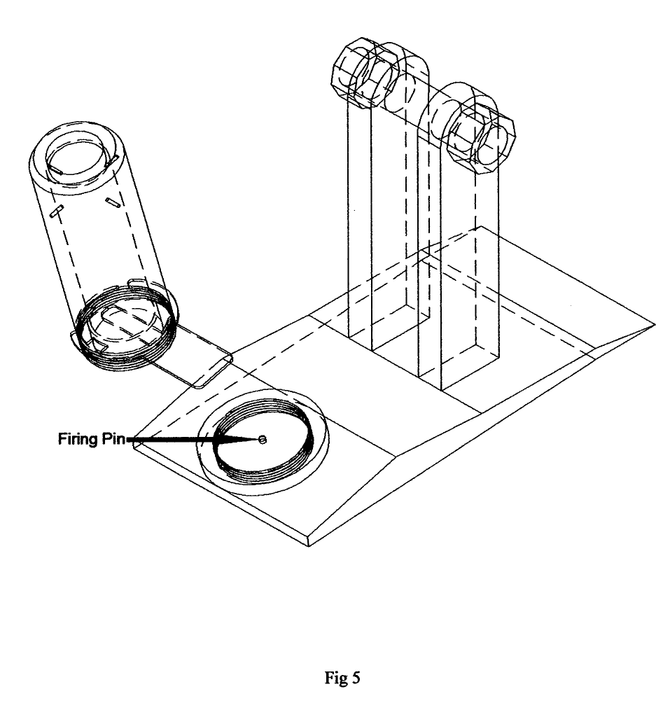

### DETAILED DESCRIPTION OF THE INVENTION

An apparatus for providing the ability to remotely breach a regular door whilst keeping personnel out of the line of fire. The device consisting of a footplate whereas the front of the plate is placed under a door. A telescoping pivoting arm connected to the center of the footplate perpendicular to the door with a weighted mass at the far end from the footplate. A removable sleeve arrangement perpendicular to the footplate and to the rear of the pivot arm. A rod running underneath and perpendicular of the pivot arm and in a position as to be inserted into the sleeve arrangement when the pivot arm is lowered. The sleeve arrangement consisting of a sleeve with a piston inside, topped by a cap with center hole of smaller diameter than the sleeve so as to maintain placement of the piston within the sleeve. A static firing pin protruding perpendicular to the foot plate central to the sleeve.

The leading edge of the footplate of the device is placed under a door. An explosive cartridge is placed within the sleeve with the primer facing downwards. The device can be activated by dropping the pivoting hammer, which in turn strikes the piston forcing the explosive cartridge onto the firing pin. The resulting explosion will force the piston and the pivoting hammer in an upward direction. This upwards force will be resisted by the pivot point thus directing the hammerhead in a circular trajectory and striking the door. The device is capable of being disassembled for transportation.

What I claim as my invention is:

1. Remote forcible entry tool, comprising:
a) a footplate to be placed underneath a conventional door;
b) a pivot point connected to the footplate;
c) A hammer head connected to a telescopic handle;
d) a hammer connected to the pivot point on the footplate at the end of the handle;
e) a perpendicular rod connected to the telescopic handle pointing downwards;
f) a screw on barrel seated perpendicular to the footplate;
g) a static firing pin perpendicular to the footplate and central to the barrel;
